(19) United States
(12) Patent Application Publication
(10) Pub. No.: US 2023/0115450 A1
(43) Pub. Date: Apr. 13, 2023

(54) METHOD AND SYSTEM FOR DETERMINING RISK IN CONSTRUCTION SITE BASED ON IMAGE ANALYSIS

(71) Applicant: SMARTINSIDE AI Inc., Suwon-si (KR)

(72) Inventors: Tae Heon KIM, Goyang-si (KR); Joo Ho SHIN, Anyang-si (KR); Seung Hee PARK, Seongnam-si (KR)

(73) Assignee: SMARTINSIDE AI Inc., Suwon-si (KR)

(21) Appl. No.: 17/877,859

(22) Filed: Jul. 29, 2022

(30) Foreign Application Priority Data
Oct. 12, 2021 (KR) 10-2021-0135121

(51) Int. Cl. G06Q 10/06; G06Q 50/08

(52) U.S. Cl. CPC G06Q 10/0635; G06Q 50/08; G06Q 10/063114

(57) ABSTRACT

According to an aspect of the present invention, there is provided a method by which an analysis server determines a risk in a construction site based on image analysis, the method including the steps of: (a) acquiring an image, taken in a construction site, from an image acquisition device; (b) identifying one or more workers in the image, and grouping the workers based on identifiers that the respective workers have; and (c) determining whether protective equipment required to be worn for each group of workers has been correctly worn by analyzing the image.

### CROSS-REFERENCE TO RELATED APPLICATION

This application claims the benefit of Korean Patent Application No. 10-2021-0135121 filed on Oct. 12, 2021, which is hereby incorporated by reference herein in its entirety.

### BACKGROUND

### Technical Field

The present invention relates generally to a method and system for determining a risk in a construction site based on image analysis, and more particularly to a method and system that enable the classification of workers and the determination of a risk for each worker based on a mobile image acquisition device.

### Description of the Related Art

Technologies for diagnosing the work safety of workers and determining risks in construction sites are being developed. In spite of these efforts, the accident rate and the death rate in construction sites are not decreasing, and a solution thereto is required.

Recently, the installation of closed-circuit televisions (CCTVs) has been made compulsory even in small- and medium-sized private construction sites, and the efficiency of safety management can be improved through the utilization of such CCTVs.

However, each construction site contains various processes depending on construction stages, so that the difficulty of image recognition in construction sites is higher than those of other fields of application. Accordingly, it is difficult to expect complete efficiency improvement even using CCTVs.

Accordingly, cases where image analysis is utilized along with a sensor combined with IoT technology in a complementary manner have emerged.

For example, a technology for preventing collisions between pieces of equipment used in construction sites and identifying the locations of workers via sensors such as beacons has emerged. However, this technology is problematic in that it is difficult to combine this technology with image analysis, multiple APs need to be installed when this technology is applied to an actual construction site, and each worker needs to wear protective gear with an IoT sensor attached thereto.

Meanwhile, the most common type of accidents in construction sites are falls of workers. The most common reason for this type of accidents is the inappropriate wearing of personal protective equipment.

Therefore, there is a need for a technology that can appropriately detect the wearing of personal protective equipment and efficiently manage safety in construction sites.

### SUMMARY

Objects of the present invention are to solve the problems of the related arts described above.

An object of the present invention is to group workers working in a construction site, determine protective equipment required to be worn for each group of workers, and determine whether each worker has worn the protective equipment required to be worn for the group of workers.

Another object of the present invention is to, in a construction site, determine safety and risk factors for each group of workers, recognize each work area, and determine a departure from the work area.

Objects of the present invention are not limited to the objects described above, and other objects not described above will be clearly understood from the following description.

According to an aspect of the present invention, there is provided a method by which an analysis server determines a risk in a construction site based on image analysis, the method including the steps of: (a) acquiring an image, taken in a construction site, from an image acquisition device; (b) identifying one or more workers in the image, and grouping the workers based on identifiers that the respective workers have; and (c) determining whether protective equipment required to be worn for each group of workers has been correctly worn by analyzing the image.

Step (c) may be performed by referring to a database that stores information about the protective equipment required to be worn for each group of workers.

The method may further include the step of determining whether at least one safety factor required to be disposed in a work space for each group of workers has been disposed by analyzing the image.

Step (a) may include the step of receiving information about an image acquisition location from the image acquisition device, and the method may further include the step of determining whether there is a worker who departs from a work area based on information about a work area for each group of workers by analyzing the image.

According to another aspect of the present invention, there is provided a system for determining a risk in a construction site based on image analysis, the system including: a worker identification unit configured to identify one or more workers in an image based on the image taken in a construction site and acquired from an image acquisition device, and to group the workers based on identifiers that the respective workers have; and a protective equipment wearing determination unit configured to determine whether protective equipment required to be worn for each group of workers has been correctly worn by analyzing the image.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing the schematic configuration of a system for determining a risk in a construction site based on image analysis according to an embodiment of the present invention; and

FIG. 2 is a block diagram illustrating the detailed configuration and operation of an analysis server according to an embodiment of the present invention.

### DETAILED DESCRIPTION

The following detailed description of the present invention will be given with reference to the accompanying drawings illustrating the specific embodiments in which the present invention can be practiced as examples. These embodiments are described in sufficient detail to enable those skilled in the art to practice the present invention. It should be understood that various embodiments of the present invention are different from each other but do not need to be mutually exclusive. For example, the specific shapes, structures, and/or features described herein may be implemented in other embodiments without departing from the spirit and scope of the invention. Furthermore, it should be understood that the locations or arrangement of individual components within each disclosed embodiment may be changed without departing from the spirit and scope of the present invention. Accordingly, the following detailed description is not intended to be taken in a limiting sense, and the scope of the present invention is limited only by the attached claims together with all equivalents to the claims. In the drawings, like reference numerals refer to the same function or a similar function throughout the various aspects.

In the following description, in order to enable those of ordinary skill in the art to easily practice the present invention, embodiments of the present invention will be described in detail with reference to the accompanying drawings.

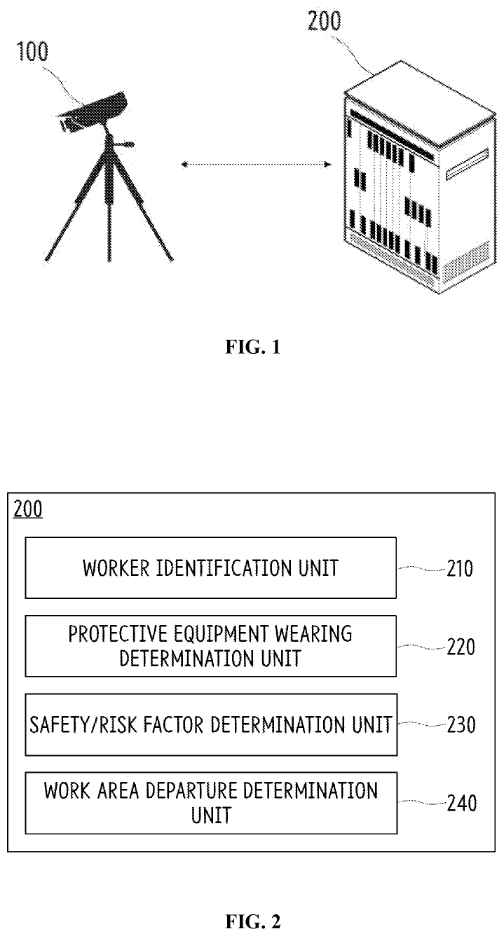

FIG. 1 is a diagram showing the schematic configuration of a system for determining a risk in a construction site based on image analysis according to an embodiment of the present invention.

Referring to FIG. 1, the system for determining a risk in a construction site based on image analysis according to the present embodiment may include an image acquisition device 100 and an analysis server 200.

The image acquisition device 100 and the analysis server 200 may communicate with each other over an intercommunication network, e.g., a LoRa network, a mobile communication network, a local area network (LAN), a metropolitan area network (MAN), a wide area network (WAN), the World Wide Web (WWW), and/or a Wireless Fidelity (Wi-Fi) network.

The image acquisition device 100 may be implemented as a mobile closed-circuit television (CCTV), but is not limited thereto. Any device having an image acquisition function may be used as the image acquisition device 100. A plurality of such image acquisition devices 100 may be disposed in a construction site. For example, the image acquisition devices 100 may be disposed at respective key positions such as an entrance door.

The image acquisition device 100 serves to acquire an image of a scene included in the field of view while moving through a construction site and then send the image to the analysis server 200. Furthermore, the image acquisition device 100 may include a location detection sensor, e.g., a GPS sensor, a GNSS sensor, or the like. When an image is sent to the analysis server 200, information about the location at which the image is acquired may be sent together with the image.

The analysis server 200 analyzes image information collected from the image acquisition device 100, identifies each worker, determines whether the worker has worn protective equipment, and determines whether the worker departs from a work area.

FIG. 2 is a block diagram illustrating the detailed configuration and operation of an analysis server 200 according to an embodiment of the present invention.

Referring to FIG. 2, the analysis server 200 according to the present embodiment may include a worker identification unit 210, a protective equipment wearing determination unit 220, a safety/risk factor determination unit 230, and a work area departure determination unit 240.

The worker identification unit 210, the protective equipment wearing determination unit 220, the safety/risk factor determination unit 230, and the work area departure determination unit 240 may be program modules or hardware capable of communicating with an external device. The program modules or hardware may be included in the analysis server 200 in the form of an operating system, one or more application program modules, or/and one or more program modules, and may be physically stored in various known storage devices. Meanwhile, the program modules or hardware include, but are not limited to, one or more routines, one or more subroutines, one or more programs, one or more objects, one or more components, one or more data structures, and/or the like that perform a specific task to be described later or execute a specific abstract data type to be described later according to the present invention.

The worker identification unit 210 serves to identify a worker by analyzing an image received from the image acquisition device 100. The identification of a worker may be performed based on the color of protective gear, e.g., a safety helmet, worn by the worker. As another example, the identification of a worker may be performed based on the color of protective equipment worn by the worker, or a symbol, a code, or the like attached to or marked on the protective equipment. To this end, in an image analysis process, a worker, and protective equipment worn by the worker, e.g., a safety helmet, may be recognized, and the color of the recognized protective equipment, or an identifier such as a symbol or code attached to the protective equipment may be determined. In other words, in the present specification, the identifier for the identification of a worker may be implemented as any identification tool attached to or worn on the body of the worker.

In a construction site, a worker may have an identifier that varies depending on the company to which the worker belongs, the type of work that is performed by the worker, or the location within the construction site at which the worker works. The worker identification unit 210 performs the operation of grouping workers based on identifiers.

The protective equipment wearing determination unit 220 serves to determine whether each worker identified by the worker identification unit 210 has worn protective equipment.

To this end, in image analysis, the recognition of protective equipment worn by each worker may be performed.

The workers grouped by the worker identification unit 210 may have different types of protective equipment required to be worn for respective groups. The protective equipment wearing determination unit 220 according to an embodiment may analyze whether each worker has worn protective equipment required for each group.

According to an embodiment, protective equipment required to be worn for each color of a safety helmet may be as follows:

TABLE 1

| | Color of | |
|---|---|---|
| Group | Safety Helmet | Protective Equipment required to be worn |
| A | orange | safety gloves a, safety shoes a, safety |
| | | vest a |
| B | red | safety gloves b, safety shoes b, safety |
| | | vest a, safety mask a |
| C | pink | safety gloves c, safety shoes c, safety |
| | | vest b, safety mask b |
| D | yellow | safety gloves d, safety shoes d, safety |
| | | vest a, safety loop |
| E | blue | safety gloves e, safety shoes e, safety |
| | | vest a, earplugs, goggles |
| F | black | safety gloves f, safety shoes b, safety |
| | | vest a, safety mask c |

In the above table, the color of a helmet represents an example of an identifier for identifying a group of workers. Protective equipment required to be worn for each group is only an example. Safety gloves ‘a’ to ‘f’ refer to different types of safety gloves. The same is applied to safety shoes, safety vests, and safety masks.

In other words, the protective equipment required to be worn may vary depending on the work location or work environment that each group of workers are responsible for. The protective equipment wearing determination unit 220 according to an embodiment determines whether protective equipment required to be worn for each group of workers has been correctly worn.

To this end, reference may be made to a database (not shown) that stores information about protective equipment required for each group of workers.

Through the above analysis, a worker who has incorrectly worn protective equipment may be identified.

When there is a worker who has incorrectly worn protective equipment, a warning message may be sent into the work space or construction site of the worker.

The safety/risk factor determination unit 230 identifies a work space for each group of workers, determines at least one safety factor required to be disposed in the corresponding work space, and recognizes whether the corresponding safety factor has been actually provided. Furthermore, the safety/risk factor determination unit 230 serves to provide notification of at least one risk factor for each work space.

According to an embodiment, a risk factor for each group of workers and a safety factor required to be disposed for the group of workers may be as follows:

TABLE 2

| | Color of | | Safety | |
|---|---|---|---|---|
| Group | Safety Helmet | Main Work | Factor | Risk Factor |
| B | red | welding | powder fire | flammable |
| | | | extinguisher | material warning |
| C | pink | structure | halogen | electric shock |
| | | construction | compound | risk |
| F | black | power | carbon | acute toxicity |
| | | construction | dioxide fire | |
| | | | extinguisher | |

In the above table, the color of a safety helmet represents an example of an identifier for identifying a group of workers, and the description of a safety factor and a risk factor for each group of workers is only an example. In other words, the type of work may vary depending on each group of workers. There is at least one safety factor that needs to be provided in a corresponding work space for each type of work to be performed, and a warning about at least one risk factor is required.

The safety/risk factor determination unit 230 identifies the safety factor and the risk factor through the database, and determines whether, for each group of workers, there is a safety factor in a work space where a corresponding worker works. If there is no safety factor, warning information informing the worker of a risk may be provided. The warning information may be provided through various methods, such as voice notification via a speaker and visual notification via a warning light.

Furthermore, for a risk factor, notification of corresponding information may be provided to a work space for each worker. The work space may be based on a concept including a space within a preset radius range for each worker.

In the foregoing description, the recognition of a worker, the recognition of protective gear or a safety helmet, the recognition of the color of the safety helmet, the recognition of protective equipment worn by each worker, and the recognition of a safety factor provided in a work space may be performed through image analysis based on a machine learning algorithm. For example, each object is modeled through the image labeling of each worker, protective gear, safety helmet, protective equipment, safety factor, etc., and it is detected whether there is a previously labeled model in a recognized image.

Furthermore, in image analysis or image labeling, a data set in a general environment (e.g., a daytime zone from noon to 6 p.m.) and a data set in a dark environment (e.g., a nighttime zone from 8 p.m. to 2 a.m.) may be merged together and then utilized. Since machine learning is performed using both the image data set in the general environment and the image data set in the dark environment, each recognition target object may be recognized regardless of the environment in which the object is placed.

Furthermore, since general object recognition shows only scores exceeding a reference value, detection is not accurately performed in environments such as an environment in which there is noise or the like. In one embodiment of the present invention, object recognition is enabled even in the presence of noise by applying Bayesian inference additionally.

The work area departure determination unit 240 serves to determine whether each worker departs from a work area for each group of workers identified by the worker recognition unit 210. Information about a work area for each group of workers may be stored in a database. The work area departure determination unit 240 may determine whether each worker departs from the work area for each group of workers based on the information stored in the database.

The location of each worker may be indirectly determined through information about the image acquisition location of the image acquisition device 100.

If there is a worker who departs from a work area, a warning message requesting the worker to return to a correct work area in a construction site may be sent.

Meanwhile, there may be a worker who departs from a limited work area (a first work area) and then performs another type of work in another work area (a second work area). In this case, protective equipment required to be worn for the first work area and the protective equipment required to be worn for the second work area may be different from each other. In this case, the protective equipment that is worn by the worker who works after moving to the second work area is determined. If protective equipment required to be worn has not been provided in the second work area, a warning message may be sent. The warning message may additionally include information about protective equipment required to be worn, and may be sent to the terminal of the corresponding worker or be sent in the form of being broadcast in the work area.

If it is determined that the worker has all the protective equipment required to be worn for the second work area, the warning message may not be sent.

For example, assuming that a specific worker departs from the first work area and enters the second work area, a warning message may be basically provided when the time for which the worker departs from the first work area is equal to or longer than a preset time. The warning message may be a warning message instructing the worker to return to the first work area when the time elapsed after the departure from the first work area is shorter than a threshold time, and may be a warning message requesting the worker to wear protective equipment required for the second work area when the time is equal to or longer than the threshold time. The reason for this is that the worker may be considered to simply depart from the work area when a short time has elapsed after the departure from the first work area while the worker may be considered to perform another type of work in the second work area when a time longer than the threshold time has elapsed after the departure from the work area.

Meanwhile, when it is determined through image analysis that the worker has worn all the protective equipment required for the second work area, the warning message may not be provided.

At least some of the operations of the analysis server 200 described above may be performed by the image acquisition device 100 on its own. For example, edge AI, which performs machine learning on its own in a hardware device or an embedded system, may be executed in the image acquisition device 100.

When all the operations of the analysis server 200 are performed by the image acquisition device 100 on its own, the above-described configuration of the analysis server 200 may be viewed as being integrated with the image acquisition device 100.

According to an embodiment of the present invention, workers working in a construction site may be grouped, protective equipment required to be worn for each group of workers may be determined, and whether each worker has worn the protective equipment required to be worn for the group of workers may be determined.

Furthermore, according to an embodiment of the present invention, in a construction site, safety and risk factors for each group of workers may be determined, each work area may be recognized, and a departure from the work area may be determined.

The foregoing description of the present invention is intended for illustration. It can be understood by those of ordinary skill in the art to which the present invention pertains that the above-described embodiments may be easily modified into other specific forms without changing the technical spirit or essential features of the present invention. Accordingly, it should be understood that the above-described embodiments are illustrative but not restrictive in all respects. For example, each component described as being of a single type may be implemented in a distributed form. Likewise, components described as being of a distributed type may also be implemented in an integrated form.

The scope of the present invention is defined by the attached claims, and all alterations or modifications derived from the meanings and scopes of the claims and their equivalents should be construed as being encompassed in the scope of the present invention.

1. A method by which an analysis server determines a risk in a construction site based on image analysis, the method comprising the steps of:
(a) acquiring an image, taken in a construction site, from an image acquisition device;
(b) classifying each worker based on a color of protective gear worn by the worker or a color of protective equipment in the image, and grouping classified workers;
(c) determining whether protective equipment required to be worn for each group of workers has been correctly worn by analyzing the image;
(d) after the analysis of the image, determining whether at least one safety factor required to be disposed in a work space has been disposed based on a type of work for each group of workers; and
(e) determining whether there is a departure from a work area for each group of workers based on information about the work area for each group of workers by analyzing the image, and, if a worker who departs from a first work area, moves to a second work area and works in the second work area is detected, preparing a message instructing the corresponding worker to return to the first work area when a time elapsed after the departure is equal to or longer than a first time and shorter than a second time, and preparing a message requesting the corresponding worker to wear protective equipment required for the second work area when the time elapsed after the departure is equal to or longer than the second time.

2. The method of claim 1, wherein step (c) is performed by referring to a database that stores information about the protective equipment required to be worn for each group of workers.

3-4. (canceled)

5. A system for determining a risk in a construction site based on image analysis, the system comprising:
a worker identification unit configured to classify each worker based on a color of protective gear worn by the worker or a color of protective equipment in an image and group classified workers, based on the image taken in a construction site and acquired from an image acquisition device;
a protective equipment wearing determination unit configured to determine whether protective equipment required to be worn for each group of workers has been correctly worn by analyzing the image;
a safety/risk factor determination unit configured to, after the analysis of the image, determine whether at least one safety factor required to be disposed in a work space has been disposed based on a type of work for each group of workers; and
a work area departure determination unit configured to determine whether there is a departure from a work area for each group of workers based on information about the work area for each group of workers by analyzing the image, and to, if a worker who departs from a first work area, moves to a second work area and works in the second work area is detected, prepare a message instructing the corresponding worker to return to the first work area when a time elapsed after the departure is equal to or longer than a first time and shorter than a second time, and prepare a message requesting the corresponding worker to wear protective equipment required for the second work area when the time elapsed after the departure is equal to or longer than the second time.
